(19) United States
(12) Patent Application Publication
(10) Pub. No.: US 2015/0356558 A1
(43) Pub. Date: Dec. 10, 2015

(54) CUSTOMER AUTHENTICATION BASED ON ACTION THE USER HAS DONE WITHIN A TRANSIT SYSTEM

(71) Applicant: Cubic Corporation, San Diego, CA (US)

(72) Inventors: Todd Nuzum, Omaha, NE (US); Robert McEntee, Encinitas, CA (US)

(21) Appl. No.: 14/734,611

(22) Filed: Jun. 9, 2015

Related U.S. Application Data
(60) Provisional application No. 62/009,800, filed on Jun. 9, 2014.

(51) Int. Cl. G06Q 20/40; G06Q 50/30

(52) U.S. Cl. CPC G06Q 20/40; G06Q 50/30

(57) ABSTRACT

A method for authenticating a user of a transit system includes creating a user account associated with a user of a transit system and receiving a display identifier associated with a payment account of the user. The display identifier is visible on a payment media associated with the payment account. A first ridership challenge answer is requested and received. A second ridership challenge answer is requested based on the received first ridership challenge answer. The second ridership challenge answer is received. The ridership challenge answers are related to interactions of the user within the transit system. A transaction identifier is identified as being associated with the payment account based on the ridership challenge answers. The display identifier is linked with the transaction identifier. The display identifier and the transaction identifier are at least partially distinct from one another. Both the identifiers are associated with the user account.

### CROSS-REFERENCES TO RELATED APPLICATIONS

This application claims priority to U.S. Provisional Patent Application No. 62/009,800 filed Jun. 9, 2014, entitled “CUSTOMER AUTHENTICATION BASED ON ACTION THE USER HAS DONE WITHIN A TRANSIT SYSTEM,” the entire disclosure of which is hereby incorporated by reference, for all purposes, as if fully set forth herein.

### BACKGROUND OF THE INVENTION

A user of transit system may access the transit system one or more times prior to deciding to purchase a monthly, unlimited, or other multiple ride pass. Oftentimes, a transit system may offer credit towards the purchase of a multiple ride pass based on the user's previous ride history. However, the user typically does not know the identifier associated with the payment media used within the transit system. This is due to many payment media having multiple primary account numbers (PAN), typically a display PAN visible on the payment media and a transaction PAN used within merchant systems. Many merchant and/or transit systems use tokenization to generate a transaction PAN or other token associated with a payment account. This transaction PAN may then be associated with a display PAN that may be stored with a financial institution, such as the issuer of the payment media. In this manner, the two PANs are stored with two separate entities using different systems. This separation of data increases the security of the payment account by making it more difficult for a person to gain access to the different information. For such systems, the user may not be able to identify the transaction PAN and/or other token, as this may be generated using a backend server and may never be provided to the user. As the user and transit or merchant systems have different PANs or identifiers, challenges exist in identifying past transactions within the transit system that the user may seek to get credit for.

### BRIEF SUMMARY OF THE INVENTION

In one aspect, a method for authenticating a user of a transit system based on interactions with the transit system is provided. The method may include creating a user account associated with a user of a transit system and receiving a display identifier associated with a payment account of the user. The display identifier may be visible on a payment media associated with the payment account. The method may also include requesting a first ridership challenge answer and receiving the first ridership challenge answer. The method may further include requesting a second ridership challenge answer based at least in part on the received first ridership challenge answer and receiving the second ridership challenge answer. The first ridership challenge answer and the second ridership challenge answer may be related to interactions of the user within the transit system. The method may include identifying, based at least on the first ridership challenge answer and the second ridership challenge answer, a transaction identifier as being associated with the payment account. The method may also include linking the display identifier with the transaction identifier. The display identifier and the transaction identifier may be at least partially distinct from one another. The method may further include associating both the display identifier and the transaction identifier with the user account.

In another aspect, a non-transitory computer-readable medium having instructions embedded thereon for authenticating a user of a transit system based on interactions with the transit system is provided. The instructions may include computer code for causing a computing device to create a user account associated with a user of a transit system and to receive a display identifier associated with a payment account of the user. The display identifier may be visible on a payment media associated with the payment account. The instructions may also include computer code for causing a computing device to request a first ridership challenge answer and to receive the first ridership challenge answer. The instructions may further include computer code for causing a computing device to request a second ridership challenge answer based at least in part on the received first ridership challenge answer and to receive the second ridership challenge answer. The first ridership challenge answer and the second ridership challenge answer may be related to interactions of the user within the transit system. The instructions may include computer code for causing a computing device to identify, based at least on the first ridership challenge answer and the second ridership challenge answer, a transaction identifier as being associated with the payment account. The instructions may also include computer code for causing a computing device to link the display identifier with the transaction identifier. The display identifier and the transaction identifier may be at least partially distinct from one another. The instructions may further include computer code for causing a computing device to associate both the display identifier and the transaction identifier with the user account.

In another aspect, a system for authenticating a user of a transit system based on interactions with the transit system is provided. The system may include a communications interface configured to send and receive data, a memory, and a processor. The processor may be configured to create a user account associated with a user of a transit system and to receive, using the communications interface, a display identifier associated with a payment account of the user. The display identifier may be visible on a payment media associated with the payment account. The processor may also be configured to provide a plurality of requests for ridership challenge answers and to receive, using the communications interface a plurality of ridership challenge answers. Each of the plurality of ridership challenge answers may be received in response to one of the plurality of ridership challenge answers. Each subsequent request of the plurality of requests may be based on a ridership challenge answer received in response to a previous request of the plurality of requests. The ridership challenge answers may be related to interactions of the user within the transit system. The processor may further be configured to identify, based at least on the plurality of ridership challenge answers, a transaction identifier as being associated with the payment account. The processor may be configured to link the display identifier with the transaction identifier. The display identifier and the transaction identifier may be at least partially distinct from one another. The processor may also be configured to associate both the display identifier and the transaction identifier with the user account.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a system diagram showing a system for authenticating a user of a transit system based on interactions with the transit system according to embodiments.

FIG. 2 shows a payment media according to embodiments.

FIG. 3 shows a swim lane diagram for a process of authenticating a user of a transit system based on interactions with the transit system according to embodiments.

FIG. 4 depicts a flowchart of a request process for authenticating a user of a transit system based on interactions with the transit system according to embodiments.

FIG. 5 depicts a process for authenticating a user of a transit system based on interactions with the transit system according to embodiments.

FIG. 6 is a block diagram of an example computing system according to embodiments.

### DETAILED DESCRIPTION OF THE INVENTION

For the purposes of explanation, the ensuing description provides specific details that are set forth in order to provide a thorough understanding of various embodiments. It will be apparent, however, to one skilled in the art that various embodiments may be practiced without some of these specific details. For example, circuits, systems, networks, processes, and other components may be shown as components in block diagram form in order not to obscure the embodiments in unnecessary detail. In other instances, known circuits, processes, algorithms, structures, and techniques may be shown without unnecessary detail in order to avoid obscuring the embodiments. In other instances, well-known structures and devices are shown in block diagram form.

The current invention relates generally to transit and transportation systems, although embodiments are not so limited. Embodiments of the invention are directed toward authentication techniques of a transit system when the customer wants to enroll in other services that the system provides. The customer's credit or debit cards are used for payments and authentication. According to some embodiments, an authentication process can prompt the user with questions to determine what they did, based on actions done within the system. For example, a user uses the bus/train or other transit vehicle, then wants to access a self-service web site to register a card or account after riding a bus/train or buying a ticket/pass.

Embodiments can utilize new and unique techniques to determine the questions to ask the customer based on transactions data and usage patterns in the system. Furthermore, the process of validating the customer responses to the questions based on a lack of customer personal data in the system, which can be utilized in embodiments of the invention, can be unique. Techniques can additionally or alternatively involve leveraging other known standards like payments but not using specific payment authentication data elements.

Oftentimes, a transit system may offer credit towards the purchase of a multiple ride pass based on the user's previous ride history. However, the user typically does not know the identifier associated with the payment media used within the transit system, as a display identifier or PAN of the payment media may not match a transaction identifier or PAN used by the transit system. To remedy this, the transit system may be configured to identify the transaction PAN by matching a series of responses by the user to a list of prior transactions conducted within the transit system. By matching the list with the responses, a list of hundreds or thousands of transactions may be quickly reduced to only transactions having a single transaction PAN. The transit system may then determine that since only one transaction PAN remains based on the user's actions, the remaining transaction PAN is likely to belong to a payment account associated with a display PAN provided by the user. The transit system may then link the two PANs and create a transit account. In some embodiments, further verification may be requested from the user prior to linking the PANs to ensure that the identified transaction PAN is in fact, associated with the proper payment account.

As one example, a customer may be presented with a first question: “Have you used the transit system?” (y/n). If yes, the customer selects the day and time you used the system (e.g., provide the date (DD/MM/YY, HH:MM). The user may be presented with a second question: “What was the type of credit card used and last for numbers of the credit card you used?” The customer may select a payment type (e.g., MasterCard®, Visa®, Discover®, American Express®) and may enter the last 4 numbers on the card. The customer may be presented a third question: “What station did you use to enter the system?” The customer may select from a list of station names. The system uses the transaction history and customer usages pattern to find a transaction and associated transaction PAN matching the received responses. It will be appreciated that different questions and/or different orders of questions may be used to locate the correct credit card number and/or transaction. The system could prompt for other action or data if desired or needed. The system does not need to prompt the user to enter the credit card number because the credit card number may be captured from a swipe, DIP or TAP at the beginning of the account creation process.

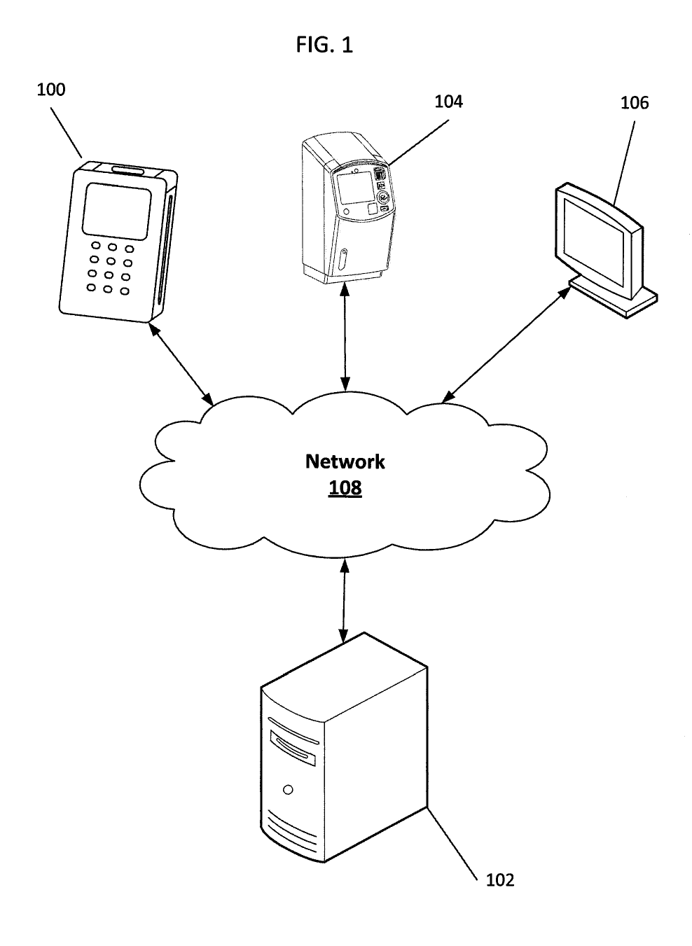

Referring now to FIG. 1, a system for authenticating a user of a transit system based on interactions with the transit system is shown. The system may include a user device 100 that may be used to interact with other components of the system via a network 108. User device 100 may include, for example, a mobile communications device such as a mobile phone or tablet computer, a laptop or personal computer, a transit kiosk or video ticket office, or any other computing device. A user device 100 includes a display, a network interface, and at least one input device to receive user inputs, such as a keyboard, touch screen, mouse, stylus, and the like. Network 108 may be a local area network (LAN) and/or other private or public wired and/or wireless networks. Network 108 may be communicatively coupled with one or more of the components of the system to facilitate communication between the various components. It will be appreciated that one or more different network connections may be used in accordance with the invention, and that the use of a single network 108 to enable communications is merely one example of such configurations. For example, each component may be communicatively coupled with other components using a separate network for one or more of the connections.

User device 100 is able to communicate with a transit server 102 or other transit system computing device. Such communications may include inputs for the creation and authentication of a transit account as described herein, including a display PAN for a payment account used to conduct the previous transit system transaction. The transit server 102 may facilitate the creation and authentication of the transit account, and may include computer logic that determines a desired order of queries to provide the user to properly locate a transaction PAN of the user's payment account and to authenticate the transit account. For example, the order of the queries or requests may be selected to reduce the number of queries needed to properly locate the transaction PANs and to authenticate the account, thereby increasing the efficiency of the authentication process. The transit server 102 may base the queries on transaction lists received from retail providers and/or transit system access devices 104. For example, a transit system access device 104 may be a transit fare gate, a video ticket office, ticket vending machine, kiosk, ticket office computing device, and the like. These transit system access devices 104 may communicate lists of transactions conducted using each device, along with corresponding transaction PANs, to the transit server 102, such as by transmitting the data as individual entries, lists, and/or databases in periodic batches and/or in real-time using network 108.

The transit server 102 may analyze data associated with the transactions within each list to determine a proper query to pose to the user device 100 to narrow the list or lists to only transactions associated with a single transaction PAN that matches answers provided by the user device 100 in response to the queries or requests. For example, the answers may be related to a time and/or date of a transaction, a location of a transaction, a cost of a transaction, a type of fare purchased in a transaction; a frequency of prior transactions using a display PAN, and other content related to a user's prior usage of a payment account within the transit system. Upon identifying the single transaction PAN, the transit server 102 may link the transaction PAN with the display PAN and associate the two PANs with a newly created transit account. In some embodiments, the transit server 102 may require verification that the transaction PAN does belong to the user by providing one or more verification queries to the user device 100. For example, the transit server 102 may communicate with a third party source 106, such as a financial intuition that issued the payment account, and receive information related to one or more transactions of the payment account outside of the transit system using network 108. Information related to one or more of these outside transactions may be provided to the user device 100, such as in a list of dummy transactions. The user must select the correct information or transaction from the dummy transactions, such as by identifying a previous purchase at a sporting event, to verify that the identified transaction PAN belongs to the payment account provided by the user.

Upon verification, the transit account may be created and/or activated with the display PAN and transaction PAN associated with the transit account. In some embodiments, prior to activation, the transit server 102 may require an activation action by the user. For example the user may be required to use a payment media associated with the payment account within the transit system and/or to perform one or more other activation actions prior to activating the transit account for use in the transit system. Upon activation, the user may present a payment media associated with the payment account and PANs to a transit system device 104, such as a kiosk or access gate, to purchase a pass or to use a pass to gain access to the transit system. For example, a user having a valid transit pass associated with the transit account may swipe, TAP, or otherwise interact with an access gate to have a gate or other physical barrier physically move to provide entry into the transit server. The user may also interact with a kiosk or other ticket vending machine to allow the user to select and purchase a transit pass with the payment account such that the pass is associated with the payment account. This allows the payment media tied to the payment account to be used to gain access to the transit server.

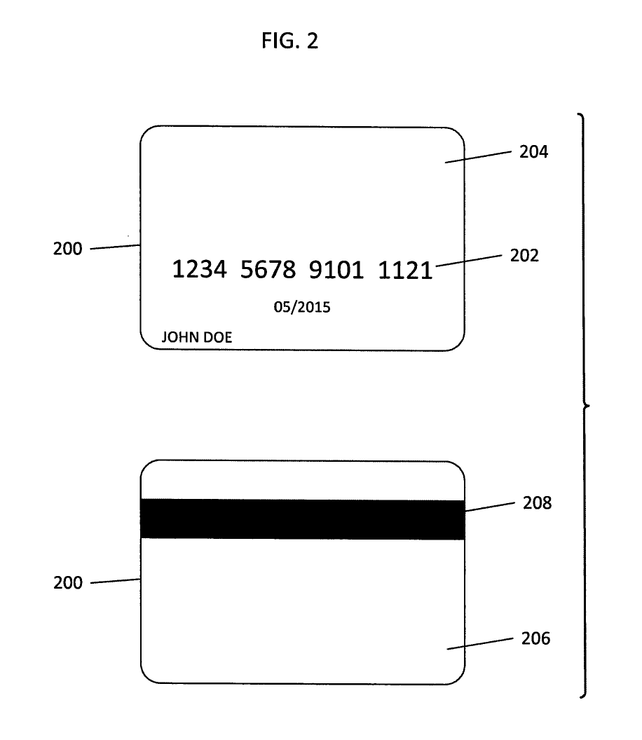

FIG. 2 depicts a payment media 200 according to one embodiment. Payment media may be in many forms, such as mobile devices, smart cards, credit cards, debit cards, and the like. Here, payment media 200 is a debit or credit card linked to a user's payment account, such as a bank account or credit card account issued by a financial institution. Payment media 200 may include a display identifier or display PAN 202. The display PAN 202 may be visible on a front surface 204 and/or back surface 206 of payment media 200. Payment media 200 may also include a magnetic stripe 208 or other mechanism for providing encoded account information to a transaction system. Oftentimes, the display PAN is the account number and/or the card number of the payment account and may be different than a PAN utilized within a transaction system. For example, many transaction systems utilize tokenization, where the display PAN is replaced with a random value, otherwise known as a token or a transaction PAN. Transaction PANs may have the format of the original display PAN or may be a unique length and combination of alphanumeric characters. While distinct from the display PAN, the transaction PAN may include one or more similar elements, such as having a subset of the alphanumeric characters match a subset of the alphanumeric characters of the display PAN. As one example, a transaction PAN may include the same last four digits as the associated display PAN, although other subset sizes and/or locations may be used. Additionally, the transaction PAN and display PAN may share no common characters. When a payment media authorization request is made, a transaction PAN might be returned to the transaction system instead of the display PAN, possibly along with an authorization code for the transaction. The transaction PAN is stored in the receiving system while the actual user data is mapped to the transaction PAN in a secure tokenization system. By storing the tokenized transaction PAN rather than the display PAN, it ensures that there is a higher level of data security associated with the use of the payment account on the transaction system.

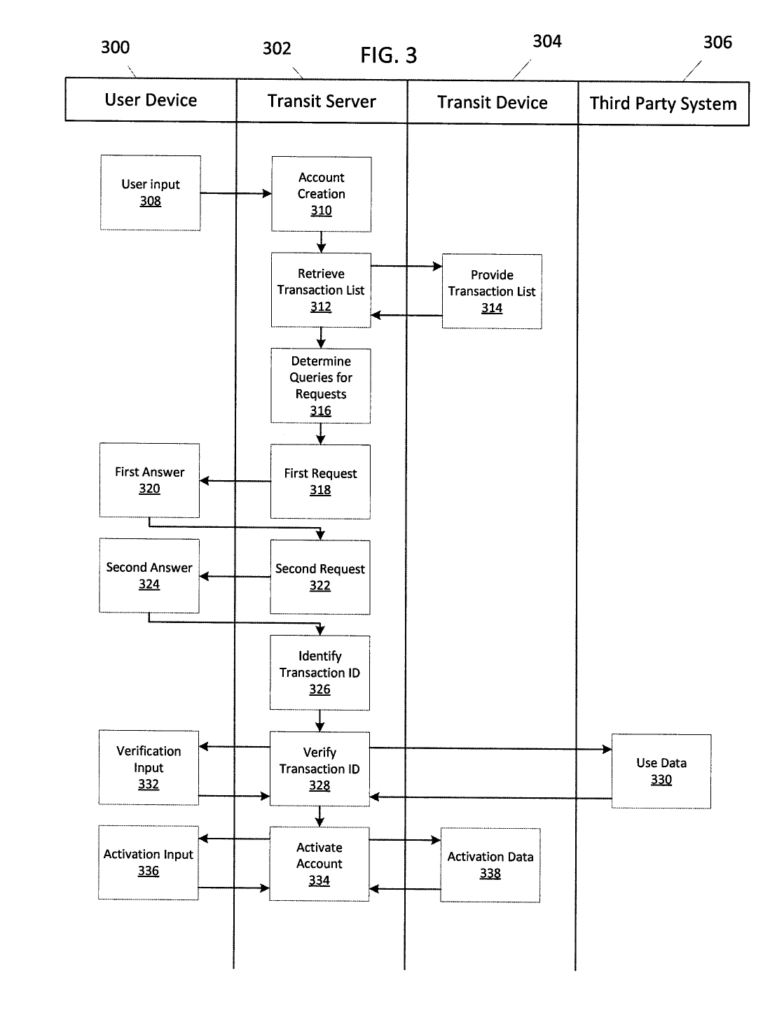

FIG. 3 shows a swimlane diagram showing interactions between a user device 300, a transit back office or a transit server 302, a transit device 304, and a third-party system 306 similar to similarly named components of FIG. 1. The user device 300 may be a mobile communications device, a personal computer, or other computing device. At block 308, a user may provide one or more inputs from the user device 300 to the transit server 302. The one or more inputs may include information identifying the user as well as contact information for the user. The information may be input by keying in information, by selecting from multiple choices provided on a display of a mobile device, and/or by automatic wireless transmission, such as by a swipe or tap of a payment media to an input device of the transit system. Additionally, the user may wish to utilize information from previous transactions, and may indicate that the user has previously accessed the transit system using one or more payment accounts. This may be particularly useful if the transit system provides discounts and/or credits toward the purchase of a transit pass based on prior usage. In such embodiments, the inputs may also include a display PAN from a payment media, such as payment media 200, with which the user previously used to conduct a transaction within the transit system. The input of a display PAN may be manually entered by the user into user device 300 and/or a transit system device 304, such as by swiping, tapping, inserting, and/or otherwise interacting with a transit system device 304 using a payment media, such as a credit or debit card, smart card, and/or mobile communications device. The information from the one or more inputs may be used by the transit server to create a transit account at block 310. The transit server 302 may then retrieve a list or database of recent transactions within the transit system at block 312. Recent transactions may include transactions within a predefined amount of time, time period, and/or may include a predetermined number of transactions. The list of transactions may be stored on the transit server 302 and/or may be retrieved from transit system devices 304, such as fare access points of the transit system. In embodiments where the list of transactions must be retrieved from transit system devices 304, a request may be sent from the transit server 302 to the transit system devices 304 for the data. Each transit system device 304 may then provide a transaction list of transactions conducted at that transit system device 304 to the transit server 302 at block 314. In some embodiments, the separate transaction lists may be aggregated to form a single list of transactions within the transit system, while in other embodiments, the transaction lists may be kept separated by location or origin device of the transaction.

Once the list or lists of transactions are retrieved, queries to be used in requests for ridership challenge answers may be determined at block 316. In some embodiments, an order of ridership challenge answer requests may be predetermined, while in other embodiments, some or all of the requests may be determined based on the initial content of the list of transactions, as well as upon the lists reduced in size. The lists may be reduced in size based on which transactions match content of received ridership challenge answers. For example, if a user indicates that his previous transit system transaction was on March 1^{st}, only those transactions that were conducted on March 1^{st} will remain on the list of transactions. All other transactions will be removed from the lists. Content of ridership challenge answers may include content that matches indexed or indexable data within the transaction lists. For example, content may include a time and/or date of a transaction, a location of a transaction, a cost of a transaction, a type of fare purchased in a transaction; a frequency of prior transactions using a display PAN, and other content related to a user's prior usage of a payment account within the transit system. By utilizing indexed data, the transit server 302 may efficiently determine the makeup of content within the list of transactions. Using this makeup, logic of the transit server 302 may determine an efficient order of queries and/or requests, for example, to minimize the number of requests that need to be sent to narrow the list of transactions to only those having a single transaction PAN that corresponds to the display PAN.

A first request for a ridership challenge answer may be communicated from the transit server 302 to the user device 300 at block 318. In some embodiments, the first request may be predetermined and is provided based on the query's priority rank, as determined by the transit system. In other embodiments, transit server logic may determine an efficient or most efficient query to pose such that the number of transactions in the list is reduced in the most efficient or likely most efficient, manner possible, such as in terms of fewest requests needed and/or total time needed to authenticate. For example, the efficiency may largely be based on a particular answer received. The transit server logic may calculate a probability of possible responses and generate an expected value associated with the number of responses that match or do not match a given response. This expected value may be used to determine a likely most efficient order of queries. For example, a query related to a type of fare may be provided. There may be any number of fare types available to choose from, such as five fare types that are equally likely. Thus, the fare type query answer will reduce the list size by 80%, as only one fare type is selected. The efficiency expected value may be 0.8 for the fare type query. A station type query may have three possible stations, which are equally likely. Thus, the station query will reduce the list 67% for an efficiency expected value of 0.67. Thus, the fare query may be selected as it has a higher efficiency expected value. It will be appreciated that the above is merely one of numbers possible permutations, and that any number of fare types, stations, and/or other query topics may be used. The efficiency expected values may include more complex calculations. Other expected values and/or valuation methods may be utilized to determine a proper order of queries.

As one example, in systems where several lists are received from various transit system devices 304, a first request may include a query for a location of the user's last transit system transaction. The user's response may eliminate a large portion of the transaction lists, as only one transit system device 302 or transit station will match the response. Other responses may be eliminated from being potential matching transactions. The user may enter an answer, such as by selecting from multiple radio buttons on a display of the user device 300 or by keying or otherwise inputting an answer on the user device 300. The first ridership challenge answer may be sent to the transit server 302 at block 320. In embodiments where the order of the queries is predetermined, the request for a second ridership answer is provided based on the priority of the query. In other embodiments, the second ridership answer request is based on a further analysis of transactions remaining on the list after the first ridership challenge answer is received. The request for the second ridership challenge answer is provided at block 322. A response to the request for the second ridership challenge answer is received from the user device 300 at block 324. One or more additional requests may be provided until enough information is received to narrow the list to a set of transactions having a single transaction PAN.

When a single transaction PAN remains, the transit server 302 may identify this transaction PAN as corresponding tot eh entered display PAN at block 326, as each of the remaining transactions matches the received ridership challenge answers. In some embodiments, the transit server 302 may require that the user offer further proof that the transaction PAN belongs to the user and is associated with the display PAN at block 328. To verify the user's ownership or control of the transaction PAN, the transit server 302 may request transaction information related to the transaction PAN from a third-party source 306. For example, an issuer of the payment account associated with the transaction PAN, merchant, or other financial institution may have information about transactions conducted using the payment account outside of the transit system. Use data may be sent from the third-party source 306 to the transit server 302 for verification purposes. For example, the transit server 302 may communicate a request for verification information to the user device 300 that includes a list of transactions. The list may include a time and/or date, a location, a price, a purchased good or service or other information of each transaction, with some of the transactions being dummy transactions. The user must then select which, if any, of the transactions listed match a transaction the user conducted using the payment account associated with the display PAN at 332. In doing so, the user is able to verify that the display PAN and the transaction PAN correspond to one another. Should the user fail in this verification step, or if the requests for answers result in zero transaction PANs, a user may either begin the authentication process from the beginning, or may back up and re-answer one or more of the ridership challenge answer queries. Some transit systems 302 may limit the number of re-answers and/or eliminate the practice altogether for security and fraud prevention purposes.

Upon verification, the display PAN and transaction PAN may be linked and associated with the transit account, which may then be activated at block 334. In some embodiments, the account may automatically be activated upon this association. However, in other embodiments, the transit system 302 may require additional action for activation. For example, the transit system may prompt the user to conduct a transaction using the payment account, complete a phone or web-based activation of the account by inputting the display PAN using a user device 300, and/or by taking other actions. A user may provide an activation input at 336, such as by making a purchase or other transaction within the transit system using the payment media at block 336. Activation data from a transit system device 304, such as a notification of the user's transaction, may be communicated to the transit server 302 by the transit system device 304 at 338. Upon receipt of the notification, the transit server 302 may activate the transit account for use. The user may then utilize the payment media as an access mechanism to the transit system, with passes and purchases being associated with the transit account.

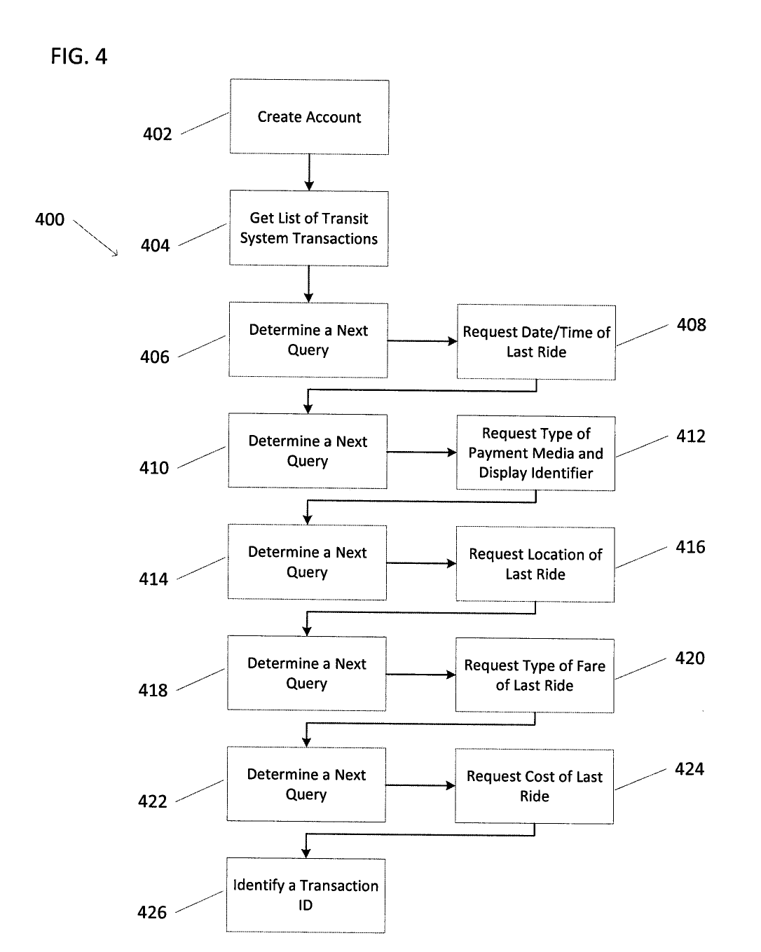

FIG. 4 depicts a flowchart of one example of an authentication process 400 for a user who has previously conducted a transaction within a transit system using a payment account. Process 400 may be conducted by a transit system, such as by a transit server similar to transit servers 102 and 302 described herein. An account may be created at block 402. The account creation may be as described elsewhere herein, with identity and/or contact information of the user being provided to the transit system, which is used to create the account. The user may be asked whether the user has conducted prior transactions within the transit system. If yes, the user may provide a display PAN associated with a payment account used to conduct the prior transaction, and the system may retrieve a list or database of transit system transactions at block 404. This list may include all transactions within a date range, and/or a predetermined number of transactions. The list may also include details about each transaction, such as a time, date, location, fare type, cost, and/or other information associated with the transaction. The transit server may maintain such lists by aggregating transaction data from transit access points, such as fare gates and/or transit fare kiosks and ticket centers. This data may be sent in batches, such as at selected time intervals, whenever a network connection is open between the transit server and transit access devices, and/or upon request. For example, the transit system may request this data upon commencing the account creation process. In other embodiments, the data is communicated from transit access points to the transit server in real-time, so the transit server always maintains updated transaction data.

Based on indexed information within the list of transactions, logic of the transit server may determine a first query to narrow the list down to only transactions matching a single transaction PAN may be identified at block 406. Upon this determination, a request is sent out for the data and/or time of the user's last transit ride or transaction at block 408. Upon receiving an answer from the user, the transit system may determine whether more than one transaction PAN is present within the list after the list is narrowed in size to only those transactions matching the date and/or time provided by the user. If more than one transaction PAN remains, the transit server may analyze the content of the transaction list to determine a next question to pose at block 410. At block 412, the system may request a type of payment media used in the prior transaction, as well as the display PAN associated with the payment media. Upon receiving an answer, the system may again determine whether a single transaction PAN remains in the list, and if not, a determination of the next query may be based off an analysis of remaining transactions of the list at block 414. At block 416, a request for the location of the last ride or transaction may be made. Upon receiving an answer, the system determines whether a single transaction PAN remains in the list, and if not, a determination of the next query may be based off an analysis of remaining transactions of the list at block 418. At block 420, a request of the type of fare of the last ride or transaction may be provided. Upon receiving an answer, the system may determine whether a single transaction PAN remains in the list, and if not, a determination of the next query may be based off an analysis of remaining transactions of the list at block 422. At block 424, the transit server may request the cost of the last ride or transaction. Upon receipt of the answer, the transit server may determine that the only transactions remaining on the list are associated with a single transaction PAN, and may identify the transaction PAN as being associated with a payment media and display PAN used by the customer at 426. The two PANs may then be linked and associated with the newly created transit account.

It will be appreciated that any order and number of questions may be provided and that the above is only representative of a single example of an authentication process in accordance with embodiments of the invention. For example, a user may be prompted to provide the display PAN at the outset of the authentication process. If at any time, the transit server determines that only one or more transactions associated with a single transaction PAN remain on the list, the determination of next query steps may be halted, and the system may identify the remaining transaction PAN as being associated with the display PAN and the payment media. Question numbers and orders may also be predetermined by a transit system to decrease the calculation complexity and thus reduce the time between queries. However, in systems where the question order is determined based on an analysis of content of the remaining list, the number of questions needed may be reduced, thus increasing the overall efficiency of the authentication process.

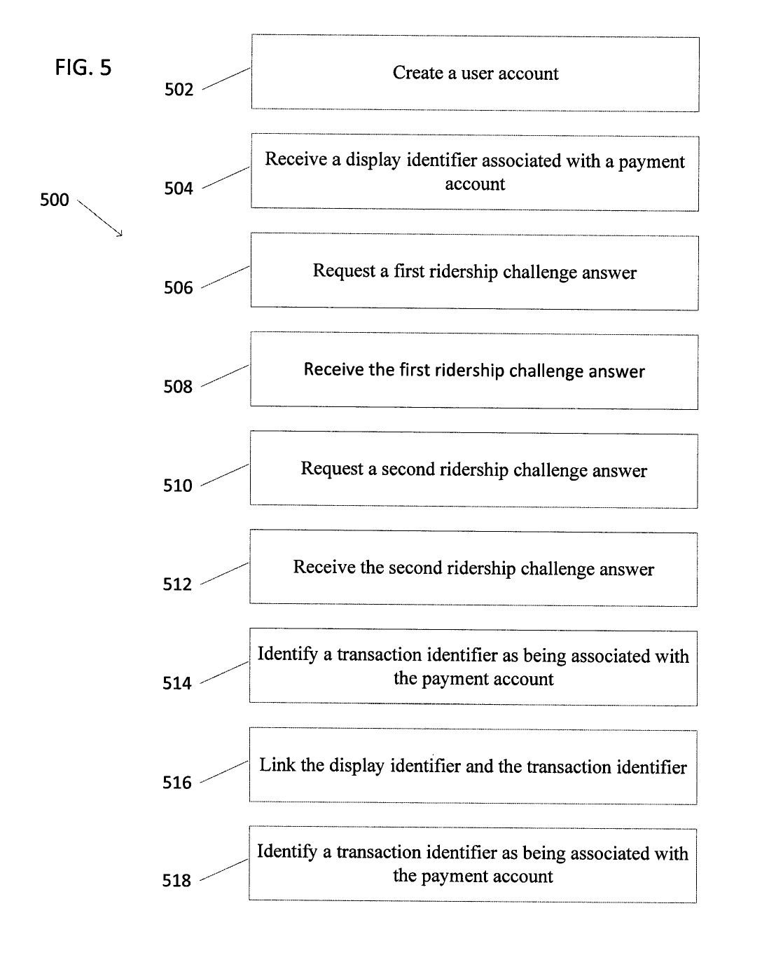

FIG. 5 shows a flowchart of a process 500 for authenticating a user of a transit system based on interactions with the transit system. Process 500 may be performed by a transit system, such as by using a transit server similar to transit servers 102 and 302 described herein. Process 500 may include similar process flows as those described in FIGS. 3 and 4. For example, a user may wish to register a payment account previously used to purchase a transit fare within a transit system. At block 502, a user account may be created. As one example, a user may provide information using a user device, similar to user devices 100 and 300 described herein, such as a mobile communications device, personal computer, or other computing device. The information may include user credentials, such as a name, address, telephone, and other contact information. A display identifier associated with the payment account of the user may be received at block 504. The display identifier may be visible on a payment media associated with the payment account. For example, a payment media such as a credit or debit card may include an identification number on a surface of the card. This number may be a display PAN such as described above in FIG. 2. Since the display PAN often does not match a transaction PAN used to identify a payment account within the transit system, a way to look up and associate this transaction PAN with the user's payment account is needed.

The transit server may look up and/or acquire a list of transactions within the transit system, such as fare purchases that are associated with payment accounts each represented by a transaction PAN. From these transactions, the transit server may use answers to a series of queries related to the user's interactions within the transit system to narrow the list of transactions and transaction PANs. At block 506, a first ridership challenge answer may be requested. The ridership question may relate to a time or date of a previous transaction within the transit system using the account associated with the display PAN, a location of the previous transaction, a cost of a previously purchased fare, a frequency of purchases within the transit system, a type of fare of a previous purchase, and other information may be requested. A first ridership challenge answer may be received at block 508. Upon receiving the first ridership challenge answer, the transit system may remove transactions that do not match the received answer and determine a second ridership challenge answer to request. For example, logic built into the transit server may be used to determine an order of challenge answers to request. The order may be determined by analyzing data known about the remaining list of answers, such as time/date, location, price, type of a fare purchase, and/or other information related to the transactions. The transit server logic may base the order on a number of factors, such as which answers will narrow down the list of transactions the quickest, thus requiring fewer requests for ridership challenge answers. In some embodiments, the list of transactions may be analyzed prior to a first ridership challenge answer being requested such that the first request may be determined to further reduce the number of requests issued, in some cases to a fewest possible number of requests. In other embodiments, an order for all requests may be predetermined. For example, a transit system provider may determine a preferred or standard order and have all authentications done using one set of prompts.

Upon determining a second challenge answer to query, the second challenge answer may be requested at block 510. As discussed above, the second challenge question may be predetermined or may be determined based on an analysis of information associated with a remaining list of transactions and transaction PANs. A second ridership challenge answer may be received at 512. Requests for ridership challenge answers may continue to be issued until the list of transactions may be narrowed down to a single transaction or set of transactions that include the same unique transaction PAN that match information within the ridership challenge answers. The set may include one or more transactions, but only a single transaction PAN. At block 514, a transaction identifier or PAN may be identified as being associated with the payment account. Identification is based, at least in part, on the first, second, and any other ridership challenge answers received in response to the requests. The display identifier or PAN and the transaction identifier or PAN may be linked at block 516. The display PAN and the transaction PAN typically will be distinct, with some or all of the letters and/or numbers being different. In some embodiments, the user device may be prompted to present verification data that ensures that the identified transaction PAN matches the payment account associated with the user and the entered display PAN. This verification data may include information related to a previous use of the payment account. For example, the previous transaction may be a transaction that was conducted using the payment account outside of the transit system. As one example, the transit system may retrieve information from an issuer of the payment account or from a third party that has information related to transactions using the payment account associated with the transaction PAN. The transit server may determine that the payment account associated with the identified transaction PAN was used to purchase tickets to a sporting event earlier that week. A prompt may be sent to the user device to request confirmation that the user did in fact use the payment account for such a purchase. This may be in the form of a direct query of did you use your payment account for a sporting event ticket purchase, in the form of a list of possible transactions from which a user must identify a recent purchase, and/or in other forms. Both the display PAN and the transaction PAN may be associated with the user account at 518, which is then activated.

The transit system may provide the user credit and/or a discount based on previous purchases within the transit system using the payment account, as determined by the transaction PAN identified in the authentication process. The payment media may then be used to gain physical access into the transit system by presenting the payment media to a transit access point, such as a gate. The user may be permitted to access based on an indication that the media is associated with a valid transit pass, such as by providing a visual light up indication, a sound indication, and/or by moving a physical barrier to permit access to the transit system. In some embodiments, linking the identifiers and/or associating the identifiers with the user account may be triggered upon receiving a notification of a completion of a confirmation action related to the payment account. For example, a user may be asked to phone in, type in or otherwise enter the display PAN into a device or system of the transit system such that the transit system may monitor this entry to ensure that the transaction PAN matches the display PAN. In other embodiments, a user may be required to make a transaction, such as a transaction using the payment media associated with the display PAN. These confirmation actions may be required to be completed within a certain time period, such as 24 or 48 hours. If such action is not completed within the time frame, the system may terminate the account creation and require the user to complete the authentication process again to ensure that the payment account information remains secure.

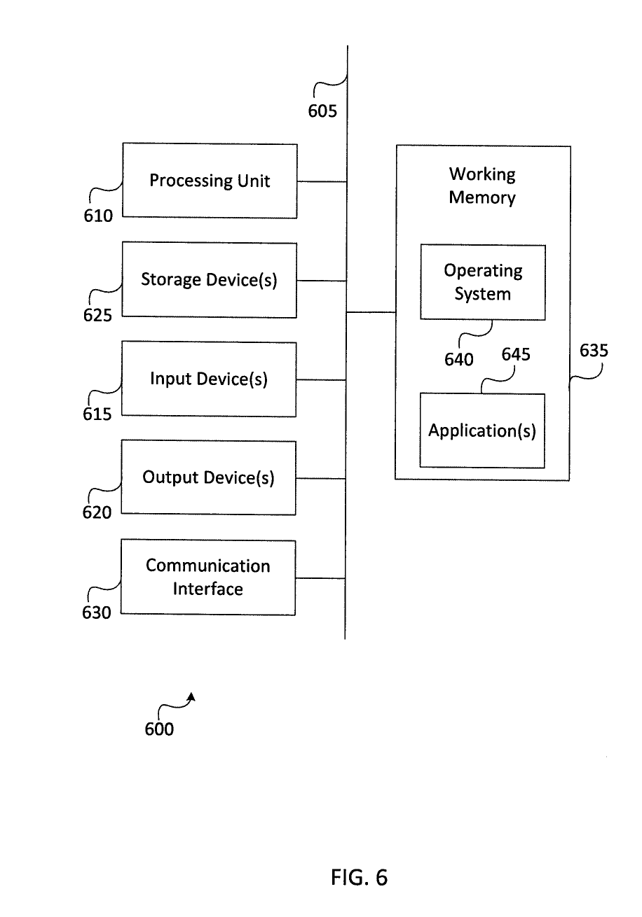

A computer system as illustrated in FIG. 6 may be incorporated as part of the previously described computerized devices. For example, computer system 600 can represent some of the components of the user devices 100 and 300, transit servers 102 and 302, transit system devices 104 and 304, and/or third party sources 106 and 306 as described herein. FIG. 6 provides a schematic illustration of one embodiment of a computer system 600 that can perform the methods provided by various other embodiments, as described herein, and/or can function as the host computer system, a remote kiosk/terminal, a ticket vending machine or other point-of-sale device, a mobile device, and/or a computer system. FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include a processing unit 610, including without limitation one or more general-purpose processors and/or one or more special-purpose processors (such as digital signal processing chips, graphics acceleration processors, and/or the like); one or more input devices 615, which can include without limitation a mouse, a keyboard, a touchscreen, receiver, a motion sensor, a camera, a smartcard reader, a contactless media reader, and/or the like; and one or more output devices 620, which can include without limitation a display device, a speaker, a printer, a writing module, and/or the like.

The computer system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 600 might also include a communication interface 630, which can include without limitation a modem, a network card (wireless or wired), an infrared communication device, a wireless communication device and/or chipset (such as a Bluetooth™ device, an 502.11 device, a WiFi device, a WiMax device, an NFC device, cellular communication facilities, etc.), and/or similar communication interfaces. The communication interface 630 may permit data to be exchanged with a network (such as the network described below, to name one example), other computer systems, and/or any other devices described herein. In many embodiments, the computer system 600 will further comprise a non-transitory working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 625 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 610, applications 645, etc.) Further, connection to other computing devices such as network input/output devices may be employed.

Some embodiments may employ a computer system (such as the computer system 600) to perform methods in accordance with the disclosure. For example, some or all of the procedures of the described methods may be performed by the computer system 600 in response to processing unit 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processing unit 610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processing unit 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 625. Volatile media include, without limitation, dynamic memory, such as the working memory 635. Transmission media include, without limitation, coaxial cables, copper wire and fiber optics, including the wires that comprise the bus 605, as well as the various components of the communication interface 630 (and/or the media by which the communication interface 630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a non-transitory storage device 625 either before or after execution by the processing unit 610.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

What is claimed is:

1. A method for authenticating a user of a transit system based on interactions with the transit system, the method comprising:
creating a user account associated with a user of a transit system;
receiving a display identifier associated with a payment account of the user, wherein the display identifier is visible on a payment media associated with the payment account;
requesting a first ridership challenge answer;
receiving the first ridership challenge answer;
requesting a second ridership challenge answer based at least in part on the received first ridership challenge answer;
receiving the second ridership challenge answer, wherein the first ridership challenge answer and the second ridership challenge answer are related to interactions of the user within the transit system;
identifying, based at least on the first ridership challenge answer and the second ridership challenge answer, a transaction identifier as being associated with the payment account;
linking the display identifier with the transaction identifier, wherein the display identifier and the transaction identifier are at least partially distinct from one another; and
associating both the display identifier and the transaction identifier with the user account.

2. The method for authenticating a user of a transit system based on interactions with the transit system of claim 1, further comprising:
receiving verification data that confirms that the identified transaction identifier matches the payment account associated with the user, wherein the verification data comprises information related to a previous use of the payment account.

3. The method for authenticating a user of a transit system based on interactions with the transit system of claim 2, wherein:
the verification data comprises information identifying a previous transaction that matches a transaction conducted using the payment account outside of the transit system.

4. The method for authenticating a user of a transit system based on interactions with the transit system of claim 1, wherein:
one or both of the first ridership challenge answer or the second ridership challenge answer is related to one or more of a time or a date of a previous transaction conducted using the payment account associated with the display identifier.

5. The method for authenticating a user of a transit system based on interactions with the transit system of claim 1, wherein:
one or both of the first ridership challenge answer or the second ridership challenge answer is related to one or more of a location, a cost, or a type of fare of a previous transaction conducted using the payment account associated with the display identifier.

6. The method for authenticating a user of a transit system based on interactions with the transit system of claim 1, further comprising:
determining a query such that the transaction identifier is determinable from a plurality of transaction identifiers using a fewest number of requests for challenge answers, wherein requesting the second ridership challenge answer comprises providing the query.

7. The method for authenticating a user of a transit system based on interactions with the transit system of claim 1, wherein:
linking the display identifier and the transaction identifier is triggered upon receiving a notification of a completion of a confirmation action related to the payment account.

8. A non-transitory computer-readable medium having instructions embedded thereon for authenticating a user of a transit system based on interactions with the transit system, the instructions comprising computer code for causing a computing device to:
create a user account associated with a user of a transit system;
receive a display identifier associated with a payment account of the user, wherein the display identifier is visible on a payment media associated with the payment account;
request a first ridership challenge answer;
receive the first ridership challenge answer;
request a second ridership challenge answer based at least in part on the received first ridership challenge answer;
receive the second ridership challenge answer, wherein the first ridership challenge answer and the second ridership challenge answer are related to interactions of the user within the transit system;
identify, based at least on the first ridership challenge answer and the second ridership challenge answer, a transaction identifier as being associated with the payment account;
link the display identifier with the transaction identifier, wherein the display identifier and the transaction identifier are at least partially distinct from one another; and
associate both the display identifier and the transaction identifier with the user account.

9. The non-transitory computer-readable medium of claim 8, further comprising instructions for causing the computing device to:
receive verification data that confirms that the identified transaction identifier matches the payment account associated with the user, wherein the verification data comprises information related to a previous use of the payment account.

10. The non-transitory computer-readable medium of claim 9, wherein:
the verification data comprises information identifying a previous transaction that matches a transaction conducted using the payment account outside of the transit system.

11. The non-transitory computer-readable medium of claim 8, wherein:
one or both of the first ridership challenge answer or the second ridership challenge answer is related to one or more of a time or a date of a previous transaction conducted using the payment account associated with the display identifier.

12. The non-transitory computer-readable medium of claim 8, wherein:
one or both of the first ridership challenge answer or the second ridership challenge answer is related to one or more of a location, a cost, or a type of fare of a previous transaction conducted using the payment account associated with the display identifier.

13. The non-transitory computer-readable medium of claim 8, further comprising instructions for causing the computing device to:
determine a query such that the transaction identifier is determinable from a plurality of transaction identifiers using a fewest number of requests for challenge answers, wherein requesting the second ridership challenge answer comprises providing the query.

14. The non-transitory computer-readable medium of claim 8, wherein:
linking the display identifier and the transaction identifier is triggered upon receiving a notification of a completion of a confirmation action related to the payment account.

15. A system for authenticating a user of a transit system based on interactions with the transit system, comprising:
a communications interface configured to send and receive data;
a memory; and
a processor configured to:
create a user account associated with a user of a transit system;
receive, using the communications interface, a display identifier associated with a payment account of the user, wherein the display identifier is visible on a payment media associated with the payment account;
provide a plurality of requests for ridership challenge answers;
receive, using the communications interface a plurality of ridership challenge answers, each of the plurality of ridership challenge answers being received in response to one of the plurality of ridership challenge answers, wherein each subsequent request of the plurality of requests is based on a ridership challenge answer received in response to a previous request of the plurality of requests, wherein the ridership challenge answers are related to interactions of the user within the transit system;
identify, based at least on the plurality of ridership challenge answers, a transaction identifier as being associated with the payment account;
link the display identifier with the transaction identifier, wherein the display identifier and the transaction identifier are at least partially distinct from one another; and
associate both the display identifier and the transaction identifier with the user account.

16. The system for authenticating a user of a transit system based on interactions with the transit system of claim 15, wherein the processor is further configured to:
receive verification data that confirms that the identified transaction identifier matches the payment account associated with the user, wherein the verification data comprises information related to a previous use of the payment account.

17. The system for authenticating a user of a transit system based on interactions with the transit system of claim 16, wherein:
the verification data comprises information identifying a previous transaction that matches a transaction conducted using the payment account outside of the transit system.

18. The system for authenticating a user of a transit system based on interactions with the transit system of claim 15, wherein:
one or both of the first ridership challenge answer or the second ridership challenge answer is related to one or more of a time, a date, a location, a cost, or a type of fare of a previous transaction conducted using the payment account associated with the display identifier.

19. The system for authenticating a user of a transit system based on interactions with the transit system of claim 15, wherein the processor is configured to:
determine a query such that the transaction identifier is determinable from a plurality of transaction identifiers using a fewest number of requests for challenge answers, wherein requesting the second ridership challenge answer comprises providing the query.

20. The system for authenticating a user of a transit system based on interactions with the transit system of claim 15, wherein:
linking the display identifier and the transaction identifier is triggered upon receiving a notification of a completion of a confirmation action related to the payment account.
